(19) United States
(12) Patent Application Publication
(10) Pub. No.: US 2013/0282606 A1
(43) Pub. Date: Oct. 24, 2013

(54) INTERNET BASED RESOURCE ACCEPTANCE, ALLOCATION AND REJECTION SYSTEM

(71) Applicant: Lokesh Mohan BHAGAT, Noida (IN)

(72) Inventor: Lokesh Mohan BHAGAT, Noida (IN)

(21) Appl. No.: 13/845,130

(22) Filed: Mar. 18, 2013

(30) Foreign Application Priority Data
Apr. 18, 2012 (IN) 1186/DEL/2012

(51) Int. Cl. G06Q 10/10

(52) U.S. Cl. CPC G06Q 10/1053
USPC 705/321

(57) ABSTRACT

An online resource management system, that comprises a first service seeking node, a second service seeking node, a server that generates a unique identification number for the first service seeking node, enables the first service seeking node to create multiple profiles using the associated unique identification number and enables the second service seeking node to fetch limited information regarding the profiles of the first service seeking nodes. The server is also configured to store, update and modify information regarding plurality of the candidate nodes and plurality of the recruiter nodes in the resource management system.

### FIELD OF INVENTION

Present Invention in general relates to management of resources and in particular relates to an internet based human resource acceptance, allocation and rejection system.

### BACKGROUND

Conventionally, online recruitment mediums and recruitment consultants have played the intermediary in recruitment of candidates. More often the consultants have relied heavily on the use web or Internet based job portals to recruit candidates. In such an arrangement, either the candidates pay a monthly, quarterly or annual fee to job portals in return of their services. Also, the service seekers (e.g companies engaging recruitment consultants and agents for their requirements expect the job of sifting and scanning through these resumes to be done by the consultants and agents. Companies that do not hire the services of the consultants and agents use the job portals directly to search for candidates. However there exists no substitute to the manual labour and time wasted or spent in scanning the resumes of the candidates by the consultants. Even though the job portals provide various keyword related searches based on skills, experience, educational qualifications, etc there still lies the problem of authenticity of resumes, current status of candidates, inactive candidates and resumes, etc. More often than not when the consultants scan through the thousands of resumes manually they find out a huge chunk of resumes to be either old, incorrect or old contact details, disinterest of candidates, etc. To add to the existing woes of the consultants and managers candidates who finally pick up the calls don't often turn up for the interview making the entire process and exercise extremely futile for the consultants, agents and managers. There exists no method to fill these existing gaps in the industry because neither the job portals can ensure the authenticity or current status of the candidate, nor the consultants or managers can guarantee if the candidates would turn up for the interview process. Conventional job portals though numerous have traditionally never focussed on after sales and value added services and solutions for companies. Once the candidate is hired neither the job portals nor the HR consultants bother beyond taking their commissions. And the candidates need to go through the same process and cycle next time they intend to change their job starting with updating their profiles and waiting to receiving interview calls.

Thus, there is a need for a system or method that not only ensures the authenticity, originality, updated current status but also automates the entire process starting from candidate selection and filtering to extending a job offer in order to save time and labour of the consultants. There is also a need for a system that integrates all the steps starting from creating a profile to receiving interview calls and also making job shifts, exit interviews, genuine and true feedback and non-hostility in getting references from previous employers.

### SUMMARY

The present invention describes an online human resource management and recruitment system. It is an objective of the invention to provide an online platform to enable better recruitment processes.

It is another objective of the invention to enable fast, efficient and reliable process of recruitment thus saving time and increasing productivity. The described invention helps the recruiters to get rid of the problem of sifting through thousands of resumes of candidates. It also presents to the recruiters correct, updated and authentic information about the candidates in pictorial, graphical and visual format. Also, disclosed is an online resource management system, the system comprising: a first service seeking node; a second service seeking node; a server, configured to perform: generate unique identification number for the first service seeking node; enable the first service seeking node to create multiple profiles using the associated unique identification number; enable the second service seeking node to fetch limited information regarding the profiles of the first service seeking request; a web interface, configured to perform: for every request made by second service seeking node to the first service seeking node, send a flag to the first service seeking node and seek permissions and restrictions on information to be shared with the second service seeking node; for every modification made by a first service seeking node to profiles, send a notification to the second server seeking node for which the second server seeking node has a permission.

It is yet another objective of the invention to enable recruiters to get rid of individually calling candidates and fixing up interviews. The described invention automates the process to the extent that after the recruiters' shortlist the candidates for the interviews real-time messages are sent to the candidates to receive their consent or refusal to attend the interviews.

It is yet another objective of the invention to help the candidates to chart out their career paths based on their possessed skill sets. The described invention also supports the recruiters to make informed decisions regarding recruitment of candidates based on the skills possessed by the candidates but at the same time not undermining the importance of other key areas requisite for the job profile. The graphical representation of a candidate's career path highlighting major milestones through pointers enable well informed decisions to be taken. In another embodiment, A resource management network, the network comprising: plurality of candidate nodes; plurality of recruiter nodes; a server node, the server node configured to: store, update and modify information regarding plurality of the candidate nodes and plurality of the recruiter nodes, generate unique identification number for each of the plurality of the candidate nodes and plurality of the recruiter nodes, and grant access to information regarding plurality of the candidate nodes and plurality of the recruiter nodes; and an interface node to enable access of the server node to plurality of the candidate nodes and plurality of the recruiter nodes and to push the unique identification number generated by the server node onto the plurality of the candidate nodes and plurality of the recruiter nodes such.

It is yet another objective of the information to provide turn-key recruitment solutions starting from the recruitment and spanning over the entire career cycle of the candidates. The described invention also provides candidates a method to maintain a record of their performance evaluated by their seniors and also compared with other candidates with same job titles and responsibilities. Also, disclosed is a community based recruitment system implemented over a network, the system comprising: a server; an web based interface; plurality of user nodes; plurality of computing devices; wherein the server is configured to respond to service request received from plurality of users made by the plurality of users using plurality of computing devices through the web based interface such that for every request received by the server from every distinct user of the plurality of user, a distinct identification number is provided and using the distinct identification number, the user can access the server for additional information in conjunction to the service request.

The present invention acts as a suggestive tool guiding and helping both the recruiters and the candidates to make important and well informed decisions in their careers.

### BRIEF DESCRIPTION OF THE DRAWINGS

The above and other features, aspects and advantages of the subject matter will be better understood with regard to the following description, appended claims, and accompanying drawings where:

FIG. 1 is a schematic block diagram illustrating an embodiment of the online human resource management and recruitment system in accordance with an exemplary embodiment of the present invention.

FIG. 2 is a schematic block diagram illustrating an embodiment of the online human resource management and recruitment system and its components in accordance with an exemplary embodiment of the present invention.

FIG. 3 is a schematic block diagram illustrating an embodiment of the online human resource management and recruitment system and module and its interfaces in accordance with an exemplary embodiment of the present invention.

FIG. 4 is a schematic block diagram illustrating an embodiment of the online human resource management and recruitment system in accordance with an exemplary embodiment of the present invention.

FIG. 5 is a flowchart showing the working of the online human resource management and recruitment system and module, in accordance with an exemplary embodiment of the present invention.

### DETAILED DESCRIPTION OF THE DRAWINGS

The preferred embodiment of the present invention and its advantages are best understood by referring to the drawings, like numerals have been used for like and correct understanding of the various drawings and hence the invention.

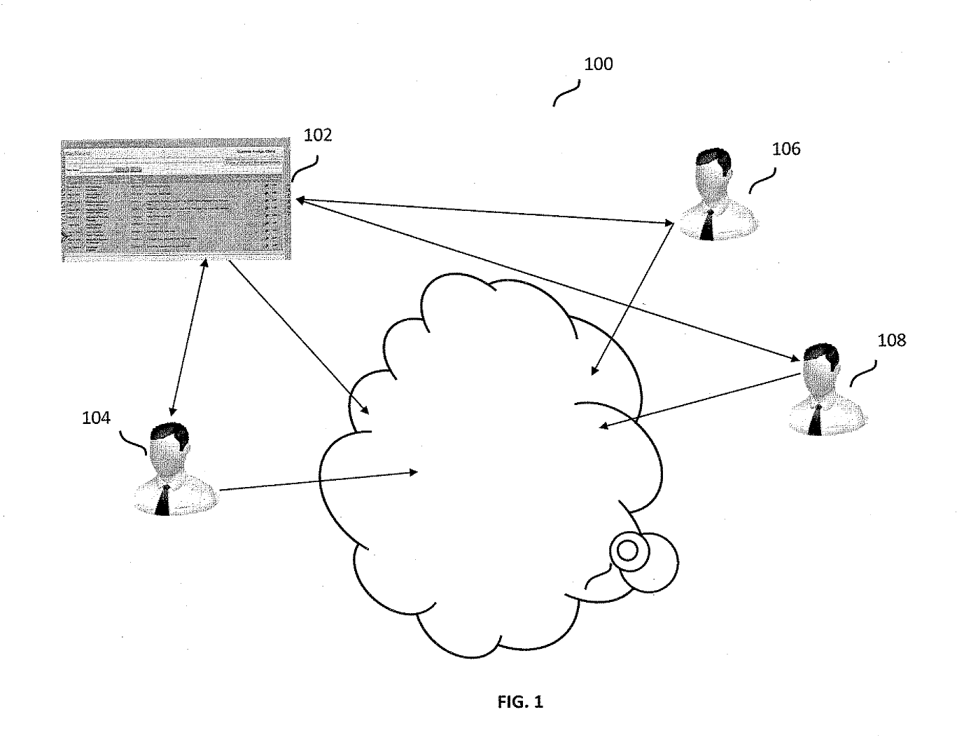

FIG. 1 illustrates the online human resource management and recruitment system 100, as described and claimed in the present invention. The illustrated online human resource management and recruitment system 100 has multiple users 104 and 106 who can be primarily classified into but not limited to recruiters/hiring managers and the candidates/applicants/job seekers. The network application 102 hereinafter referred to as Leucid for Recruitment or LFR is an online platform that provides secure, reliable and efficient method for recruitment. The leucid for Recruitment or LFR enhances the efficiency of the recruitment process and provides both the recruiters/hiring managers and the candidates/applicants/job seekers with time saving and fast method of getting genuinely connected.

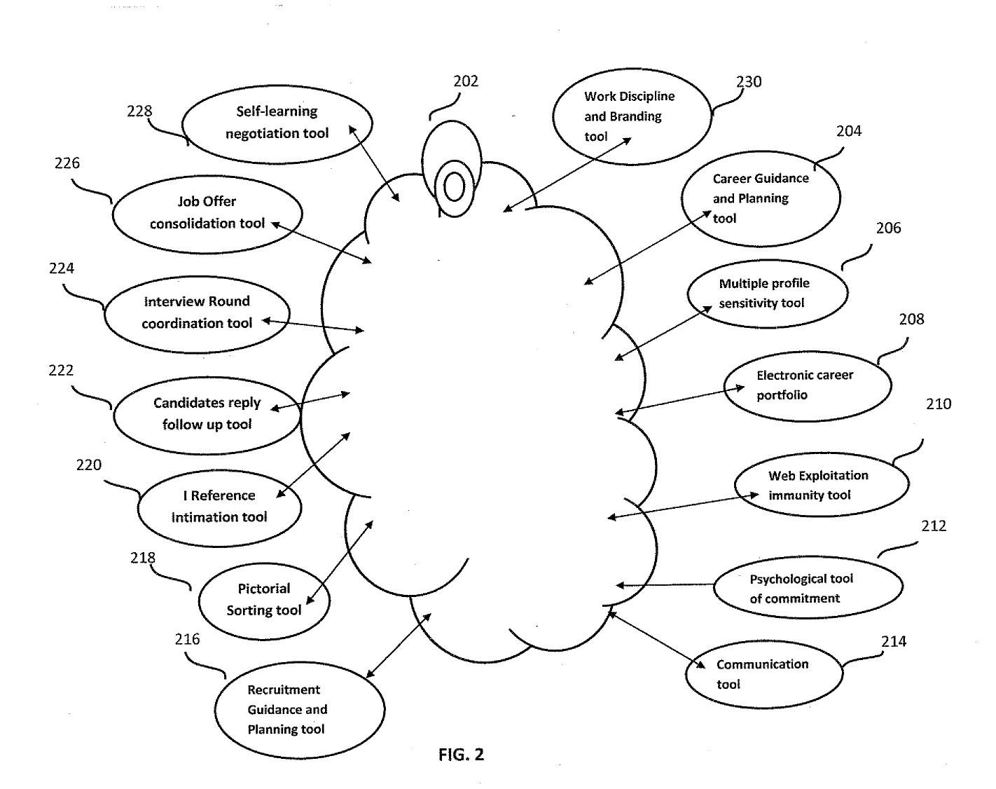

FIG. 2 illustrates the online human resource management and recruitment system 200 and its components as described and claimed in the present invention. The illustrated online human resource management and recruitment system 200 has multiple components and tools to enable the users primarily the recruitment team and candidates/job seekers to make learned and informed decisions at different stages of the recruitment process. The career guidance and planning tool hereinafter 204 referred to as CGPT helps candidates to plan their careers in a more effective way owing to its features such as “Skill based Job title possibilities”, “Job title based degrees & diplomas” and “Job title based career path to plan future”.

Skill based Job title possibilities as the name suggests focuses on the skills of the candidates and not on the educational qualifications and requisites. Candidates or job seekers link themselves to predefined skill sets by selecting the predefined skill set/skill sets that describe the skills possessed by them. Candidates choose/select the skills and interest areas that are suited to them the most and are closest, same or similar to the ones possessed by them. Candidates or job seekers can also add skill/skill sets that are not predefined in the network application and also describe the same in detail. Job seekers in cases when they don't find the skills or interest areas of their choice can enter the skills they feel they possess and also enter the relevant details elucidating and explaining the skills and interest areas in detail. The LFR 202 then updates the newly added skill/skill set and the corresponding description in its database. The predefined skill sets (that are selected by the candidate or job seeker) are mapped with the job description selected/added by the recruiter/hiring manager and the filtered candidates with the required skills for the Job are thus listed. The network application or LFR 202 is a self-learning and suggestive application. Under the Job title based degrees & diplomas feature, the LFR 202 suggests the candidates of educational qualifications, degrees, diplomas and other professional programs required for a particular Job. For example if the Job title for a Job profile is Accountant, and the recruiter/hiring manager has held the importance of educational qualifications as equal or more important than the skill sets necessary, the LFR 202 would suggest the candidate of degrees, diplomas, or other specific programs in accountancy. The LFR 202 would also go a step further and list out the places in priority from where the necessary qualification can be garnered along with other course details such as fees, duration, location, etc. Components of Job description such as skills, educational qualification, salary range, etc can be given priorities by the recruiter/hiring managers. Based on the priorities set by the recruiters/hiring managers, the candidates filtered would be listed. The network application 202 owing to its suggestive nature also enables users (job seekers) to plan their career paths.

The network application or LFR 202 draws parallels with other candidates registered with it or in its database. For example if a user or job seeker intends to view his probable career path based on his current job title and profile, this feature comes in as a very useful support. The network application 202 charts out a career path after comparing with all the other existing users who had or have the same or similar job titles and profiles. The chart would be both indicative and suggestive. It indicates to the users or job seekers when, how and where would they reach based on their current job title and profile. It also suggests to them if they can reach to a different or varied designation/profile than their current profile. The chart which is a projection of the career of the user or job seeker is an amalgamation of information garnered from other users that had or have same or similar job titles and profiles. The chart includes points or milestones to indicate how the users made shifts or decisions in their careers and at what points to reach where they are at that time. It would also indicate to the users of the importance and balance between the skills and educational qualifications possessed and maintained by other people that had or have same or similar job titles and profiles in their careers. The career path charted out by the network application 202 is graphical representation of the skills gathered, education pursued, companies/organizations joined and left and areas of interest of people who had at some point in time in their careers or have the same or similar job title or profile as the user whose career path is charted out.

The multiple profile sensitivity tool 206 enables the users or job seekers to create multiple profiles. Job seekers can create multiple profiles based on their varied areas of interest. It also thus helps job seekers to receive multiple job offers based on their multiple profiles. For example users or job seekers can create multiple profiles depending on their areas of interest which could range from dancing to writing to legal to finance, etc. The users unlike with the existing online recruitment platforms do not create different user names and passwords for their multiple profiles. The network application 202 provides a mechanism to keep multiple profiles based on areas of interest using one single user name and password. The multiple profile sensitivity tool 206 also thus gives the flexibility to the users or job seekers to choose their career path based on the job offers received by them for their desired multiple profiles. The Electronic Career portfolio 208 is a graphical representation of the job seeker's career. It is an alternate to the conventional resume. The Electronic Career portfolio 208 hereinafter referred to as ECP is a graphical presentation of interests, skills, achievements and experience of a candidate. The ECP 208 is exhaustive to the extent that it takes into account all major and minor achievements of a candidate starting from his college to present. The recruiters/hiring managers are able to better understand the “fit for the job” nuance with the help of the ECP 208. The graphical representation includes pointers to indicate the job shifts, achievements/awards, salary/compensation hikes. The pointers can be clicked further to view the pop-up windows detailing the information associated with the pointer. The recruiters/hiring managers also have the option to view the ECP 208 in video format. The video format is a video presentation of the candidate's career. The length of the video though depends on the information involved but is restricted to not more than 5 minutes. The ECP 208 in the video format is more exhaustive than the conventional video resumes and also provides the job seekers/candidates/applicants and users to use voice-overs in the background in addition to the option of using their own voices. The video format of the ECP 208 doesn't read out the conventional resumes but explains and presents the graphical representations of the candidate's career in video format.

The Web exploitation immunity tool 210 or WEIT is another useful component of the network application or LFR 202. With the primary objective of providing control over personal information of a candidate's identity WEIT lets users or job seekers protect their contact details from being exposed to everyone at random. Contact details of the candidates are exposed on web by the network application or LFR 202 only after receiving the SMS/message confirmation from the candidate. Job seekers receive invitation for interviews only from the companies that they have selected from the list of the companies on the network application 202. In a case when a job seeker receives a interview call from a company, but he is not willing or interested to attend the interview, the candidate or the job seeker can choose to keep his identity hidden from the company/recruiter/hiring manager. It should also be noted that the network application or LFR 202 doesn't reveal the contact details of the job seekers or users to the recruiters/hiring managers till the time a confirmation is received from the job seeker. The ECP 208 that is presented to the recruiter/hiring manager doesn't contain the contact details of the job seeker. The details exposed to the recruiter/hiring manager are only limited to information about the candidate or job seeker's skill sets, work experience, age, interests and other information that is relevant to the recruiter/hiring manager in enabling him to decide to call the candidate for the interview or not.

The psychological tool of commitment 212 or PTC plays the role of providing psychological motivation to candidates to obey the interview calls accepted by them. Basically, more often than not candidates or job seekers don't turn up for the interviews even when they have accepted or committed to attending the interview. None of the existing online job portals or job consultants or agents have been able to provide with a long term solution to address this issue. But the LFR with its PTC 212 feature/component addresses this issue with a tangible solution. The probability of candidates or job seekers profiles to get displayed (when next time any recruiter/hiring manager search for a candidate for a certain vacancy in their company) goes down drastically if they fail to attend the interview process after having given confirmation for the same. This not only reduces their chances of receiving interview calls but also their chances of getting ignored by the recruiters/hiring managers. The network application or LFR 202 puts a mark against the icon of that particular candidate or job seeker indicating his past behaviour/experience. However, in cases when the job seeker or the candidate informs the system of his absence from the interview process due to certain eventuality, no such action as mentioned above would be taken by the network application 202. The candidates or job seekers can use the communication tool 214 to inform the interviewer. The communication tool 214 enables the users or job seekers to send a SMS intimation or message to inform the interviewer. The message is received by the network application 202 which further informs the interviewer of the candidate's inability to attend the interview. This also takes care of the problem of the candidate not being able to reach or inform the interviewer (doesn't have the contact details) directly.

The communication tool 214 as already briefed above is one of the most important components of the network application 202. The tool facilitates communication between various parties involved in the transaction. The users or job seekers can use the communication tool 214 not only to inform the interviewer of his inability to attend the interview process (if he has accepted to attend the interview) but also to change and update their profile information and status. The communication tool 214 enables the users or job seekers to communicate with the network application or LFR 202 even in the absence of internet connection. Users can use their mobile phones to send the message about changing the profile status from active to passive or vice-versa. Active and passive profile statuses imply user's or job seeker's interest in receiving interview or job offers with active indicating affirmative and passive indicating negative.

The Recruitment and guidance planning tool 216 or RGPT as the name suggests is a tool to enable recruiters/hiring managers/companies to make well informed decisions with respect to the candidates or job seekers. RGPT 216 helps companies to explore alternate educational qualifications that can be suited to meet their requirements. For example when a company intends to hire an accountant and emphasizes on a particular educational qualification (priority over skills), RGPT 216 provides recruiters/hiring managers with an option of exploring other suited candidates with slightly varied (priority wise) and in some cases highly varied educational qualifications but with the requisite skill sets and experience needed for the job. But in spite of listing candidates with the requisite skill sets for the job of an accountant, priority would still be given to listing candidates with the desired educational qualification first (priority set by the recruiter/hiring manager). RGPT 216 provides an alternate option or in other terms informs or spreads awareness amongst the recruiters/hiring managers of looking at candidates/job seekers with a different educational qualification but the requisite skills for the job profile but at the same time not imposing its virtue of skill based recruitment heavily on the recruiters/hiring managers. RGPT 216 similar to CGPT 204 uses the ECP 208 to present the recruiters/hiring managers with graphical representations or the video of the career path of the candidates or job seekers. The ECP 208 links the educational qualifications, achievements, interests, skills with the career paths of the users or job seekers, and thus enables the recruiters to judge a job seeker or candidate's suitability for a job based on the skills possessed and interests even in the absence of the requisite educational qualification. RGPT 216 uses the graphical representations based on the actual career paths and similar working and job environment (based on the information provided by the recruiter/hiring manager) and doesn't project or chart out a candidate or job seeker's career path (like in CGPT). The ECP 208 used by RGPT 216 thus enables the recruiters/hiring managers to look and also try out other candidates other than those that meet their need for the required educational qualification.

Pictorial sorting tool 218 or PST basically uses icon and pictorial representation of job seekers to make the short-listing process quicker and efficient. ECP 208 also forms a major sub component of the PST 218. Icon based representation of candidates not only includes representing male and female candidates with male and female icons respectively but also enables recruiters/hiring managers to view or glance through the basic details about the candidate just by taking the cursor to the icon. The pop-up window that gets displayed when the recruiter/hiring manager takes the cursor to the icon contains basic information about the candidates or job seekers such as age, location, work experience (but no name or contact details), etc. On further clicking on the respective icon of a particular candidate or job seeker, recruiters/hiring managers are taken to the webpage that contains the ECP 208 of the candidate.

Reference intimation tool 220 or IRIT and Candidate reply follow up tool 222 or CRFT are used in tandem by the network application or LFR 202. When the recruiter/hiring manager selects a particular candidate for the interview process a automatic intimation is sent to the candidate in real-time. The intimation message sent to the candidate contains a unique id that is generated in real-time after various permutations & combinations of the company id, candidate id and the “new job posted by the company” id. Apart from the unique id the message also contains information about the job description and the company. The message that is sent to the candidate by IRIT 220 contains a “I reference digital flag” that allows job seekers or candidates to view information about the job profile and the company. The candidates can also select the time slot preferred to them for the interview by using the “I reference digital flag”. When the candidates agree to attend the interview and send a confirmation message, they would receive another message from the network application with multiple digital flags. The CRFT 222 uses the message with multiple digital flags to follow up with the candidates or job seekers after they have agreed to attend the interview. CRFT 222 allows candidates or job seekers to control and select what and how much more information (that the candidates feel would be relevant) from their ECP 208 (in addition to the information already viewed by the recruiter/hiring manager) and or their resume they want to share with the recruiter/hiring manager. The various digital flags mentioned in the message enable the candidates to control the amount of information shared. The candidates can select a particular flag and the level of information (stored in the database of the network application 202) associated with that particular flag is sent to the recruiters/hiring managers. The CRFT 222 provides candidates or job seekers with the freedom of controlling the extent of information shared with the recruiter/hiring manager but it doesn't enable the users or candidates or job seekers to hide any information (relevant to the profile) from the recruiters/hiring managers. The digital flags sent to the candidates or job seekers by CRFT 222 are unique and enable the job seekers or candidates to control the sharing of information which the LFR 202 finds to be not relevant to the job profile mentioned. After receiving the reply to the message the information (corresponding to the digital flag selected) and contact details would be shared with the recruiter/hiring manager.

The Interview round coordination tool 224 or IRCT plays a pivotal role in cases when there are multiple rounds of interviews or multiple interviews at multiple locations. However, in cases when there is a single interview round the role of IRCT 224 is equally useful. After every round of interview the interviewer can fill the comments and feedback section and the IRCT 224 consolidates the feedback and comments and presents them in a simplified form to the HR manager or the concerned authority. The HR manager or the concerned person can then make a informed decision on the selection of the candidate. In cases when the each interview round is an elimination round, IRCT 224 based on the feedback from the interviewer enables better communication between the HR manager/concerned person and the interviewer. The HR manager or the concerned person after reading the feedback of the interviewer can inform the candidate of the next process or step through the communication tool 214. Job offer consolidation tool 226 or JOCT and the IRCT 224 complement each other. The feedback and comments entered by interviewer/interviewers after conducting the interview are consolidated by the IRCT 224. The consolidated report like format enables the authorised person to make informed decision on the next course of action with respect to the interviewed candidate.

The Self-learning negotiation tool 228 or SLNT comes into the picture after the recruiter/hiring manager/company decides to extend the offer to the candidate or job seeker. This tool enables company to see other offer flags made to the same candidate by other companies at that point of time without disclosing the details of the other companies and the time of the offer. But the recruiter/hiring managers would be allowed to view other offers only after the network application or LFR 202 receives approval from the candidate. At the time of extending the offer the recruiter or hiring manager would be exposed to the other job offers (if any) extended to the candidate or job seeker. The job offers exposed to the recruiter/hiring manager would be for jobs that have the same or similar job description as the current job profile. However, the SLNT 228 doesn't expose the offered CTC and the company names of the companies that have extended the offer but only the number of offers. If the candidate intends to negotiate further after receiving the job offer, he can then choose to expose to the HR manager/concerned authority the name of the company and the offered CTC to express his interest to negotiate. However, if the candidate doesn't have any other offer and doesn't reply to a particular offer extended by one company, the offer would stand expired beyond the specified time period.

If the candidate accepts the offer to join the company the network application or LFR 202 updates the profile of the candidate automatically to add the new job title and company. Work Discipline and Branding tool 230 or WDBT like all the other tools can be used by only those candidates and companies that are registered with the network application LFR 202. The recruited candidates fill a predefined form corresponding to their job title and work output every day. Recruited candidates choose or select the options from the predefined form that correspond to their daily work tasks and output. In cases when the candidates perform certain additional tasks that are not part of their daily work cycle, they can add details about the task. The reference point or benchmark for the filled forms are generated after comparing with the same or similar forms filled by other recruited candidates for the same job titles. The self evaluation or remarks filled by the recruited candidates for themselves are anchored or commented on by their superiors. The e-mail address of the immediate superior or the concerned authority for the recruited candidates is used by WDBT 230 to send them daily reports filled by the recruited candidates under them. The superiors or the reporting authority receives a mail in real-time as and when the recruited candidates under then fill their daily report. The superior can then write his/her comments without actually logging into the network application 202. Another party that is kept in the loop is the senior or the super boss to avoid any sort of bias of the superior or the reporting authority towards the recruited candidate. The superiors or the reporting authority need to write their comments on the recruited candidate's report within 3 days post which the self evaluated report of the candidate (for the day for which the 3 day cap is over) would be considered verified and correct. For example if a candidate is constantly receiving negative comments from his/her superior for his work output, the recruited candidate can prove his/her work quality and get the comments corrected or rectified within the stipulated period of time. WDBT 230 is primarily focussed towards solving the problem of getting genuine reference letters from the old companies or superiors when employees move to a new job. The daily report card filled by the candidate not only gives the control in the hands of the candidates but also ensures verification, genuineness and authenticity of the report card. The candidates can present the report card to their new recruiters as an alternate to the reference letters. The report card of the candidates not only contain the genuine feedback and comments of the seniors but also a comparison of the performance of the candidate vis-a-vis other candidates registered on the network application 202 having same or similar work cycles, tasks and job titles. WDBT 230 also presents to probable recruiters a performance record of the candidate and thus helps them to make a well informed decision to shortlist the candidate. However, the information exposed to probable recruiters is not detailed but enough to take a decision. The detailed information on the performance record of the candidate is exposed to the recruiter (also acts as an alternate to the reference letters) only when the job offer is extended to the candidate.

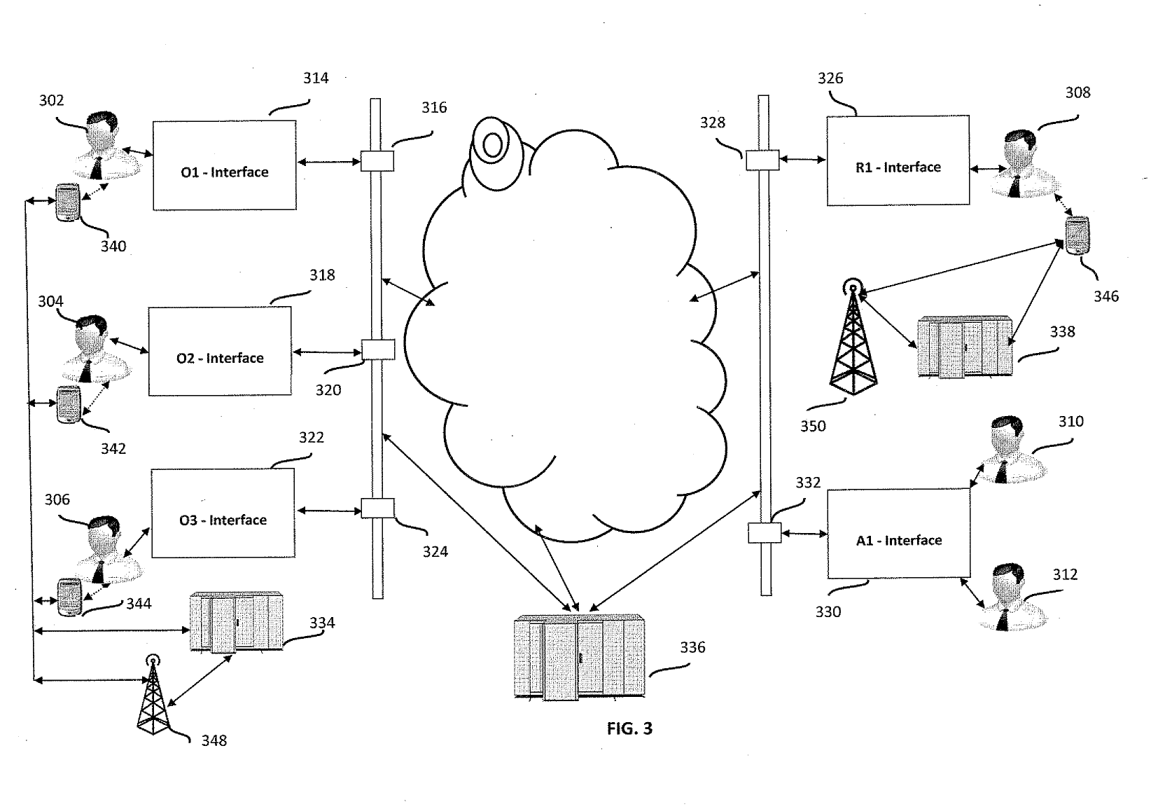

FIG. 3 illustrates the online human resource management and recruitment system and module 300 and its interfaces as described and claimed in the present invention. The illustrated online human resource management and recruitment system 300 has multiple users who can primarily be divided into two major segments recruiters/hiring managers/companies and job seekers/candidates. The O1 interface section 314 is a graphical user interface. The O1 interface section 314 allows users (Human resource managers 302) to interact with the electronic devices such as computers, mobile phones, tablets, etc through the network application or LFR. The graphical user interface 314 is primarily meant to support and enable the Human resource managers 302 to shortlist candidates for the interview process to fill job vacancies in their companies. On1 node 314 is a interface carrier or a hardware interface. The interface carrier On1 node 314 may include but is not limited to USB, FireWire, Ethernet, DVI, HDMI, PCI, PCI Express, etc.

The O2 interface section 318 is a graphical user interface. The O2 interface section 318 allows users (Human resource employers 304) to interact with the electronic devices such as computers, mobile phones, tablets, etc through the network application or LFR. The graphical user interface 318 is primarily meant to support and enable the Human resource employers 304 to recruit candidates to fill job vacancies in their companies. The human resource employer 304 uses the graphical user interface 318 to view and check the feedback of the candidates after the interview and extend the job offers to the candidates. On2 node 320 is a interface carrier or a hardware interface. The interface carrier On2 node 320 may include but is not limited to USB, FireWire, Ethernet, DVI, HDMI, PCI, PCI Express, etc.

The O3 interface section 322 is a graphical user interface. The O3 interface section 322 allows users (interviewers 306) to interact with the electronic devices such as computers, mobile phones, tablets, etc through the network application or LFR. The graphical user interface 322 is primarily meant to support and enable the interviewers 306 to conduct interviews. Interviewers 306 use the graphical user interface 322 to stay informed of the interviewees shortlisted by the human resource managers 302 and also of the time slots selected by the interviewees for the interview. On3 node 324 is a interface carrier or a hardware interface. The interface carrier On3 node 324 may include but is not limited to USB, FireWire, Ethernet, DVI, HDMI, PCI, PCI Express, etc. The R1 interface section 326 is a graphical user interface for the candidates or job seekers 308. The R1 interface section 326 allows users (candidates or job seekers 308) to interact with the electronic devices such as computers, mobile phones, tablets, etc through the network application or LFR. The graphical user interface 326 is primarily meant to support and enable the candidates or job seekers 308 to create, manage and update their profiles. Candidates or job seekers 308 use the graphical user interface 326 to plan their careers, view job postings by companies, check notifications received, update their profile statuses, choose companies they want to work for and also select the interview time slots. Rn1 node 328 is a interface carrier or a hardware interface. The interface carrier Rn1 node 328 may include but is not limited to USB, FireWire, Ethernet, DVI, HDMI, PCI, PCI Express, etc. The A1 interface section 330 is a graphical user interface for the back-end support staff 310 and 312. The A1 interface section 330 allows back-end support staff 310 to process various users (job seekers 308 and recruiters/hiring managers/companies 302, 304 and 306) related issues, keep a track of the information exchanging hands and resolving user queries. An1 node 332 is a interface carrier or a hardware interface. The interface carrier An1 node 332 may include but is not limited to USB, FireWire, Ethernet, DVI, HDMI, PCI, PCI Express, etc.

The mobile telephone units 340, 342, 344 and 346 are used by human resource managers 302, human resource employers 304, interviewer 306 and job seekers 308 respectively. The communication tool of the network application or LFR uses the SMS servers 334 and 338 to send and receive messages to the job seekers 308 and human resource managers 302, human resource employers 304 and interviewer 306. The SMS servers 334 and 338 provide the network facility for sending or receiving SMS transmissions to or from a telecommunications network. The base application server 336 is used primarily to process and execute the applications and features of the network application or LFR. The base application server 336 may include but is not limited to java application servers, .NET, PHP application servers, etc. The network antenna 348 and 350 or cellular radio towers enable mobile phones, to communicate with each other and with fixed transceivers and telephones anywhere in the network, via base stations. The cellular radio tower 348 is used by the telephone service provider for the users (human resource managers 302, human resource employers 304 and interviewer 306) and the cellular radio tower 350 is used by the telephone service provider for the job seekers 308.

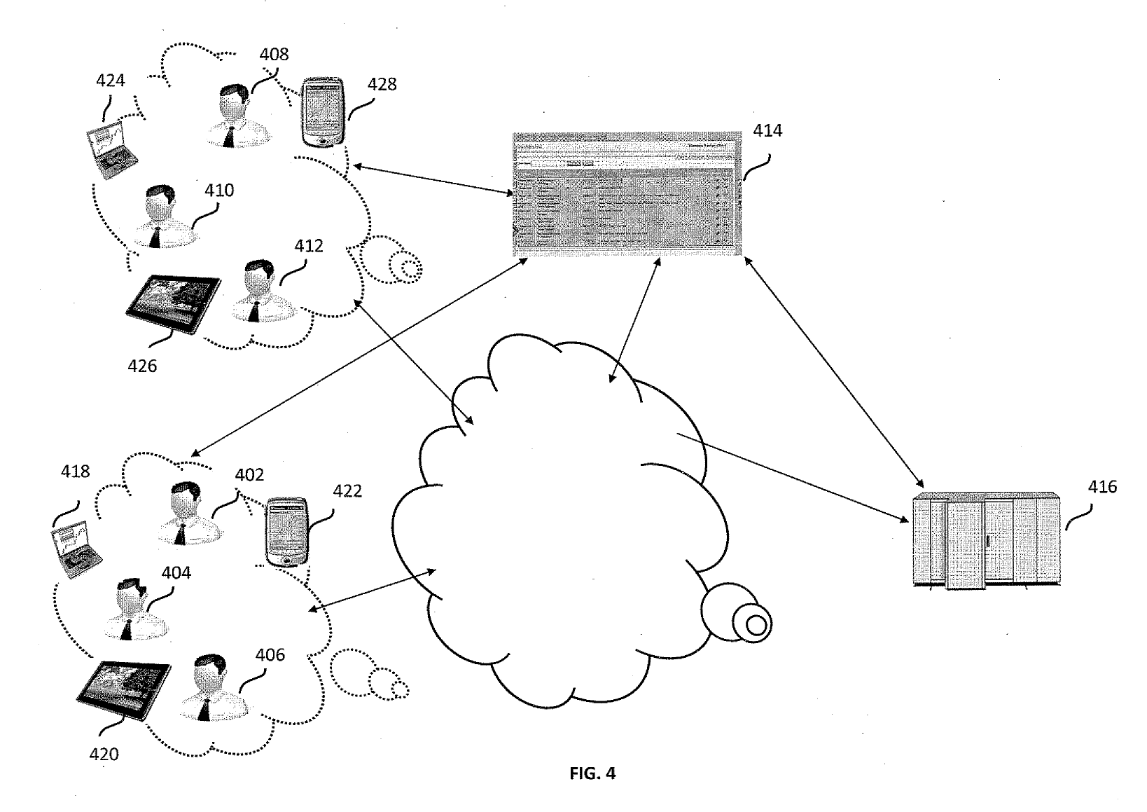

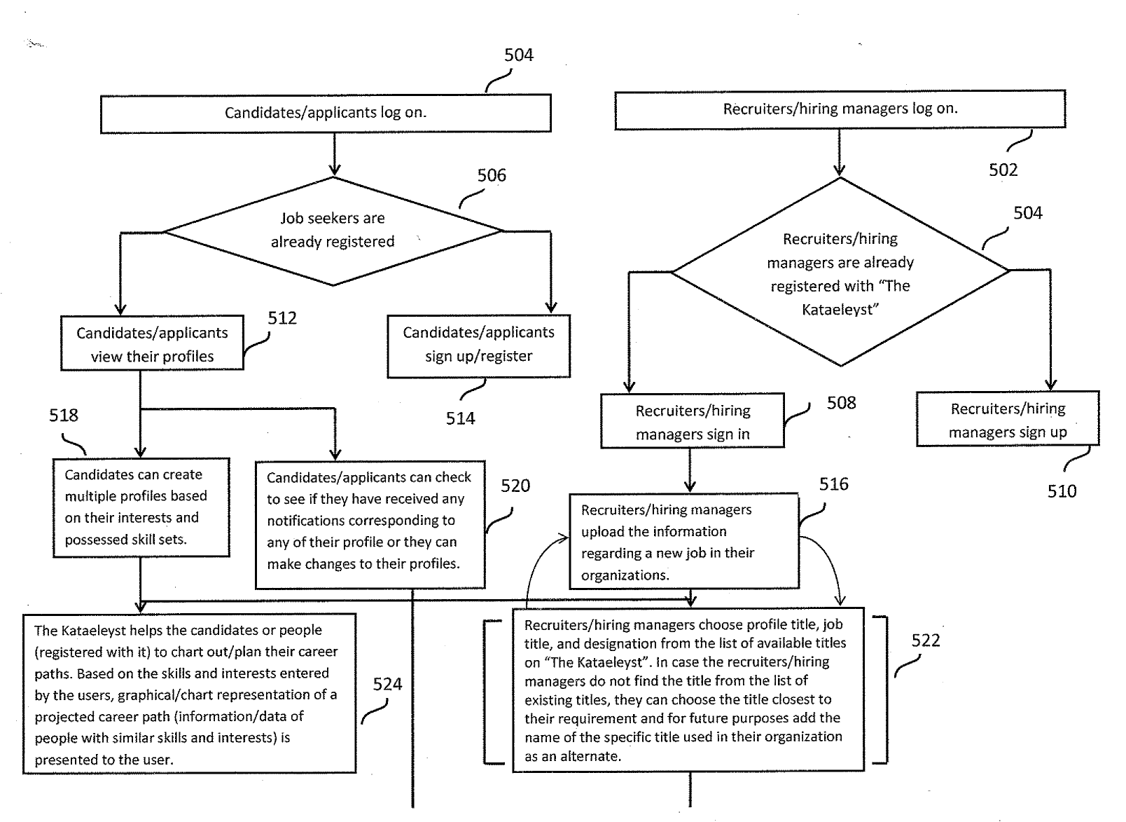

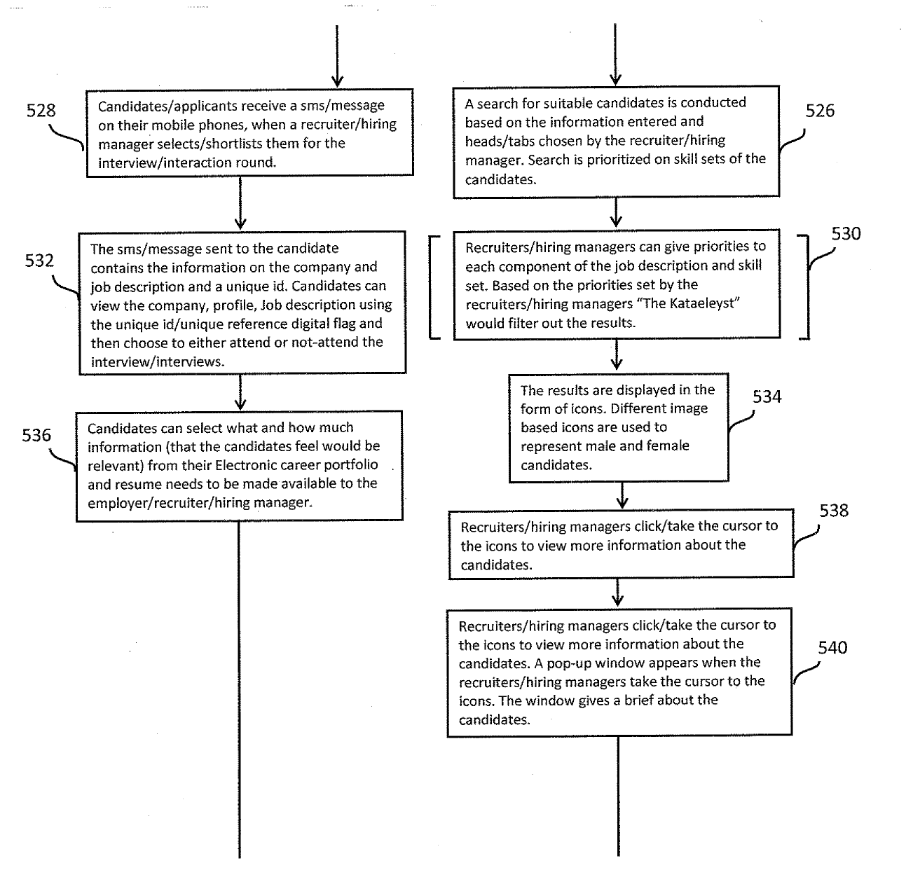

FIG. 4 illustrates the online human resource management and recruitment system 400 as described and claimed in the present invention. The illustrated online human resource management and recruitment system 400 has multiple users who can primarily be segmented into candidates or job seekers 402, 404 and 406 and recruiters/hiring managers 408, 410 and 412 who may be seeking services from their respective network connections. These network connections may include but not limited to, Ethernet, local area network (LAN), wide area network (WAN), virtual local area network, and proprietary networks. The users have associated computing devices, these devices may include but not limited to desktop, tablet 420 and 426 computers, mobile phones 422 and 428, laptops 418 and 424, and servers. The application server 416 handles all application operations between users (candidates or job seekers 402, 404 and 406 and recruiters/hiring managers 408, 410 and 412) and the backend business applications, databases used by the support staff. The application server 416 may include but is not limited to Java application servers, .NET, PHP application servers, etc.

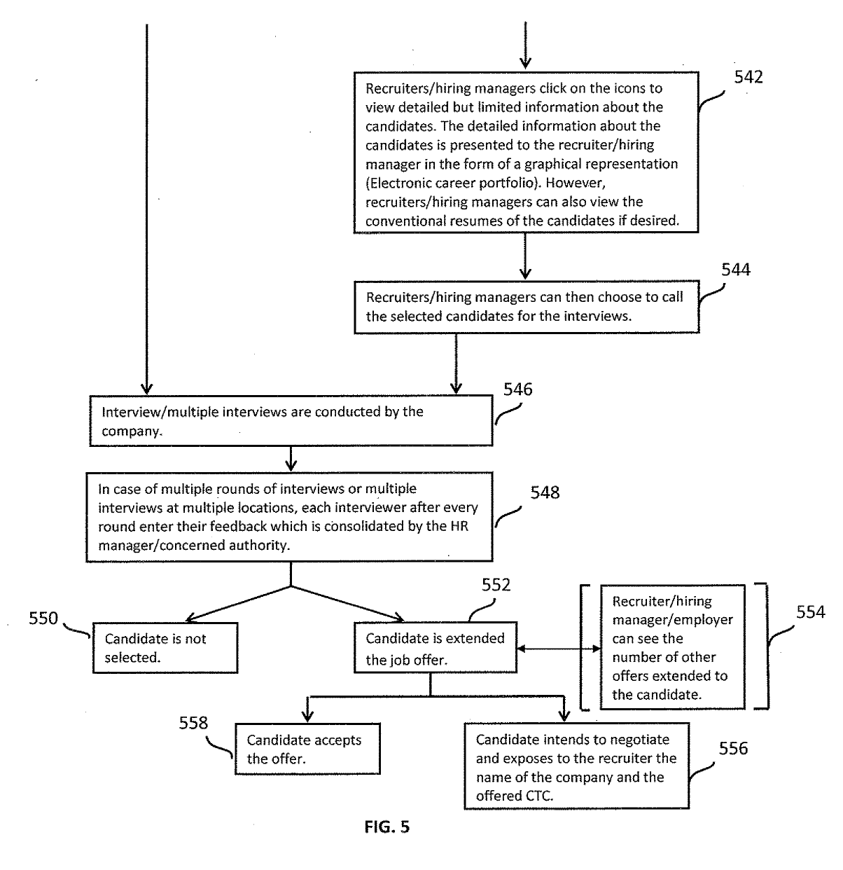

Now, referring to FIG. 5 which is a flowchart showing the process of communication between job seekers and recruiters/hiring managers and steps involved, in accordance with an exemplary embodiment of the present invention. At operation 502 recruiters/hiring managers 408, 410 and 412 log on to their computing devices. The associated computing devices, may include but are not limited to desktop, tablet 420 and 426 computers, mobile phones 422 and 428, laptops 418 and 424, and servers. At operation 508 if the recruiters/hiring managers 408, 410 and 412 are already registered with the network application or LFR they can sign in to access and use the features of LFR. At operation 510 if the recruiters/hiring managers 408, 410 and 412 are not registered with the network application they can sign up by filling the fields required and start accessing and using the features and applications of LFR.

At operation 504 users or job seekers 402, 404 and 406 log on to their computing devices. The associated computing devices, may include but are not limited to desktop, tablet 420 and 426 computers, mobile phones 422 and 428, laptops 418 and 424, and servers. At operation 512 if the job seekers 402, 404 and 406 are already registered with the network application or LFR, they can sign in to access the features of the LFR and view their profiles. At operation 514 if the job seekers 402, 404 and 406 are not registered with the network application or LFR they can sign up by filling the fields required and start accessing and using the features and applications of LFR.

At operation 516, recruiters/hiring managers 408, 410 and 412 access their company or organization specific webpage on the network application and upload details about the new job vacancy or vacancies with their company/organization. At operation 522 the recruiters/hiring managers 408, 410 and 412 fill the requisite fields explaining and elucidating the Job description. The network application presents to the recruiters/hiring managers 408, 410 and 412 a list of the specific fields associated with the job description. The specific fields associated may include but are not limited to skill sets, job title, work experience, education qualifications, etc. The recruiters/hiring managers 408, 410 and 412 further choose/select (after selecting the field) from the list of existing options corresponding to the field chosen. In cases when the recruiters/hiring managers 408, 410 and 412 don't find the requisite option in the list of existing options, they can either choose the closest option or enter their option which would then get stored and added to the list of existing options from next time. For example if the recruiters/hiring managers 408, 410 and 412 need to upload information about a “marketing executive” profile with their company but do not find the job title “marketing executive” available or mentioned in the existing job titles under the job title field, they can either choose the title which they feel is the closest to their profile requirement or add a new job title “marketing executive” to the list of existing job titles. While choosing or selecting a particular job title the associated detailed information corresponding to the job title that pops up in a window enables the recruiters/hiring managers 408, 410 and 412 to make informed decisions. The job titles are further divided under sub-categories like marketing, finance, legal, etc which helps recruiters/hiring managers to directly scan the job titles relevant to their line of business and job profile and not scroll through each and every job title.

At operations 518 after the job seekers 402, 404 and 406 sign in the network application or LFR they can view their profile. The job seekers 402, 404 and 406 can create multiple profiles with the same user name and password but based on different skills and interest areas. At operation 520 after the job seekers sign in the network application or LFR, they can check their profiles for any notifications, update their profile statuses or update their profile information. At operation 524 the users or job seekers 402, 404 and 406 use one of the features of the network application. The network application or LFR through its tool Electronic Career portfolio 208 enables and supports the users or job seekers 402, 404 and 406 to plan or chart out their career paths. For job seekers 402, 404 and 406 with multiple profiles based on varied skills and interest areas, ECP 208 helps them draw their probable career paths. The ECP 208 presents to the job seekers 402, 404 and 406 a graphical representation of their probable career path from their current job title and profile to where they can reach in a certain time horizon. The career path is charted out based on the comparisons with the profiles of other people registered with the network application who posses similar or same skills and interests as the concerned user. The chart includes various pointers indicating job shifts, educational qualifications, achievements in people's careers. The ECP 208 provides an indication to the users or job seekers 402, 404 and 406 that with their skill sets and interest areas what could their career path like and also with their current job title and profile where could they reach in a certain time horizon. The network application uses its tool career guidance and planning tool or CGPT 204 that helps candidates to plan their careers in a more effective way. CGPT 204 uses ECP 208 to present to the job seekers 402, 404 and 406 graphical representation of their probable career path that is based on the comparison with other people's profile. The comparison takes into account the people and their educational qualifications, similar or same skills and interest areas, similar or same job title and profile (at any point in their career). The ECP 204 apart from being an indicative tool is also a suggestive tool. The network application also provides job seekers with the option of viewing the graphical representation in a video format.

At operation 526, recruiters/hiring managers 408, 410 and 412 initiate the search for suitable candidates by filling the required specific fields corresponding to the job description. The specific fields associated may include but are not limited to skill sets, job title, work experience, education qualifications, etc. At operation 530 the recruiters/hiring managers 408, 410 and 412 can also give priorities to the fields corresponding to the job description. When filling the job description details one by one the recruiters/hiring managers 408, 410 and 412 can choose to prioritize the specific details such as skills as top priority followed by educational qualifications and vice versa, etc. Based on the priorities set by the recruiters/hiring managers 408, 410 and 412 the network application or LFR would filter the results. If the recruiters/hiring managers 408, 410 and 412 do not give priorities to specific fields in the Job description, the network application by default would set skill sets as the top priority.

At operation 534 the network application or LFR lists out the filtered candidates who are suited to the job description entered by the recruiters/hiring managers 408, 410 and 412. The network application uses icon based representation to represent candidates. Male and female image based icons are used to represent the candidates. The network application uses its Recruitment guidance and planning tool or RGPT 216 to suggest to the recruiters/hiring managers 408, 410 and 412 to focus on skill based recruitment. For example if a recruiter/hiring manager is in need of an accountant for his company, the network application would in addition to people with the requisite educational qualification would also list out candidates who possess the necessary skills such as proficient in Microsoft excel, number crunching and interest in accounting and mathematics, etc. RGPT 216 helps companies to explore alternate educational qualifications that can be suited to meet their requirements. RGPT 216 provides an alternate option or in other terms informs or spreads awareness amongst the recruiters/hiring managers of looking at candidates/job seekers with a different educational qualification but the requisite skills for the job profile but at the same time not imposing its virtue of skill based recruitment heavily on the recruiters/hiring managers. RGPT 216 uses the ECP 208 to present the recruiters/hiring managers with graphical representations or the video of the career path of the candidates or job seekers. The ECP 208 links the educational qualifications, achievements, interests, skills with the career paths of the users or job seekers, and thus enables the recruiters to judge a job seeker or candidate's suitability for a job based on the skills possessed and interests even in the absence of the requisite educational qualification. RGPT 216 uses the graphical representations based on the actual career paths and similar working and job environment (based on the information provided by the recruiter/hiring manager) and doesn't project or chart out a candidate or job seeker's career path. The ECP 208 used by RGPT 216 thus enables the recruiters/hiring managers to look and also try out other candidates other than those that meet their need for the required educational qualification.

At operation 538, recruiters/hiring managers 408, 410 and 412 can place and cursor or click on the image based icons. Pictorial sorting tool 218 or PST basically uses icon and pictorial representation of job seekers to make the short-listing process quicker and efficient. ECP 208 also forms a major sub component of the PST 218. Icon based representation of candidates not only includes representing male and female candidates with male and female icons respectively but also enables recruiters/hiring managers to view or glance through the basic details about the candidate just by taking the cursor to the icon. At operation 540 the pop-up window that gets displayed when the recruiter/hiring manager takes the cursor to the icon contains basic information about the candidates or job seekers such as age, location, work experience (but no name or contact details), etc. At operation 542 on further clicking on the respective icon of a particular candidate or job seeker, recruiters/hiring managers are taken to the webpage that contains the ECP 208 of the candidate. The ECP 208 is a graphical representation of job seeker's career. ECP 208 for a job seeker highlights skills, interests, achievements and awards in college and at job, job titles and profiles, appraisals, etc. The graphical representation includes pointers to indicate the job shifts, achievements/awards, salary/compensation hikes. The pointers can be clicked further to view the pop-up windows detailing the information associated with the pointer. The recruiters/hiring managers also have the option to view the ECP 208 in video format. The video format is a video presentation of the candidate's career. The ECP 208 in the video format is more exhaustive than the conventional video resumes and also provides the job seekers/candidates/applicants and users to use voice-overs in the background in addition to the option of using their own voices.

At operation 544 recruiters/hiring managers 408, 410 and 412 decide to call the candidates or job seekers 402, 404 and 406 for the interview after viewing their details. At operation 528 job seekers 402, 404 and 410 receive a message in real-time informing them of their short-listing by the recruiter/hiring manager 408, 410 and 412. The network application or LFR uses I Reference intimation tool 220 or IRIT, Candidate reply follow up tool 222 or CRFT and communication tool 214 in tandem to inform, follow up and coordinate with the candidates shortlisted by the recruiters/hiring managers 408, 410 and 412. At operation 532 the intimation message sent to the candidate contains a unique id and information about the job description and the company. The message that is sent to the candidate by IRIT 220 contains a “I reference digital flag” that allows job seekers or candidates to view information about the job profile and the company. At operation 536 the candidates can also select the time slot preferred to them for the interview by using the “I reference digital flag”. The CRFT 222 uses the message with multiple digital flags to follow up with the candidates or job seekers after they have agreed to attend the interview. CRFT 222 allows candidates or job seekers to control and select what and how much more information (that the candidates feel would be relevant) from their ECP 208 (in addition to the information already viewed by the recruiter/hiring manager) and or their resume they want to share with the recruiter/hiring manager. The various digital flags mentioned in the message enable the candidates to control the amount of information shared. The candidates can select a particular flag and the level of information (stored in the database of the network application 202) associated with that particular flag is sent to the recruiters/hiring managers. The CRFT 222 provides candidates or job seekers with the freedom of controlling the extent of information shared with the recruiter/hiring manager but it doesn't enable the users or candidates or job seekers to hide any information (relevant to the profile) from the recruiters/hiring managers. When the candidates agree to attend the interview and send a confirmation message, they would receive another message from the network application with multiple digital flags.

At operation 546 interviews are conducted for the candidates. After the interview the interviewer enters his feedback or comments on the specific webpage in the network application. At operation 548 in cases of multiple interview rounds or multiple interviews at multiple locations, interviewers enter their comments or feedback on specific webpage in the network application. The network application or LFR uses its Interview round coordination tool or IRCT 224 consolidates the feedback and comments and presents them in a simplified form to the HR manager or the concerned authority. The HR manager or the concerned person can then make a informed decision on the selection of the candidate. The HR manager or the concerned person after reading the feedback of the interviewer can inform the candidate of the next process or step through the communication tool 214. At operation 550 the HR manager or the concerned person decides to not select the candidate. At operation 552 the HR manager or the concerned person decides to extend the offer to the candidate.

At operation 554 the network application discloses to the HR manager/concerned person the number of other offers received by the candidate at that point of time. The network application uses its self-learning negotiation tool or SLNT 228 to provide the selected candidates an opportunity to negotiate in case they are not satisfied with the job offer. At operation 556 the selected candidate intends to negotiate further with the company. The selected candidate can then choose to expose to the HR manager/concerned authority the name of the company and the offered CTC to express his interest to negotiate. At operation 558 the selected candidate accepts the job offer. If the candidate doesn't accept or express his interest to negotiate for a certain period of time the extended job offer expires to become null and void.

I claim:

1. An online resource management system, the system comprising:
a first service seeking node;
a second service seeking node;
a server, configured to perform:
generate unique identification number for the first service seeking node;
enable the first service seeking node to create multiple profiles using the associated unique identification number;
enable the second service seeking node to fetch limited information regarding the profiles of the first service seeking node;
a web interface, configured to perform:
for every request made by second service seeking node to the first service seeking node, send a flag to the first service seeking node and seek permissions and restrictions on information to be shared with the second service seeking node;

2. The system of claim 1, wherein the profiles are created basis predefined parameters associated with the service seeking node.

3. The system of claim 2, wherein complete access is provided to the second service seeking node upon permissions from the first service seeking node.

4. A resource management network, the network comprising:
plurality of candidate nodes;
plurality of recruiter nodes;
a server node, the server node configured to:
store, update and modify information regarding plurality of the candidate nodes and plurality of the recruiter nodes,
represent information about the candidate nodes in a graphical format illustrating their career paths,
the graphical representation of the career paths of the candidates is two-versioned both actual and projected
send unique flags to the candidate nodes upon receiving instructions from the recruiter node, and
an interface node to enable access of the server node to plurality of the candidate nodes and plurality of the recruiter nodes,

5. The network of claim 4, wherein the interface node enable creation, updating, modification and removal of service seeking request by plurality of the recruiter nodes and broadcasting the request to the plurality of the candidate nodes.

6. The network of claim 5, wherein the service seeking request is a job posting.

7. The network of claim 4, wherein the server displays plurality of candidates matching the requirements in the service seeking request.

8. The network of claim 7, wherein the recruiter node views the graphical representation of the candidate's career path to shortlist the candidates.

9. The network of claim 8, wherein the server sends a unique flag through message to the plurality of candidate nodes selected/shortlisted by the recruiter nodes for information about the work order.

10. The network of claim 9, wherein the flag contains information pertaining to the service request.

11. The network of claim 4, wherein the plurality of candidate nodes, using the interface node, access the server node and selects one or more of the service seeking request to confirm a work order.

12. The network of claim 11, wherein the server sends unique flags through message to the candidate node upon selection of a work order

13. The network of claim 12, wherein the flags contain information pertaining to more information fields about the candidate nodes other than those already exposed to the recruiter nodes and thus seeking the permission of candidate nodes to expose more information fields to the recruiter nodes.

14. The network of claim 11, wherein information relating to the selected work order is conveyed to one or more of the plurality of recruiter node.

15. The network of claim 14, wherein the work order is a schedule for interview.

16. An internet based resource management network, the network comprising:
a candidate node;
a recruiter node;
a server, configured to:
enable communication between the candidate node and the recruiter node;
provide customized self-learning applications relating to service offer negotiation, interview round coordination, career and recruitment guidance and planning.

17. The network of claim 16, wherein the candidate nodes is configured to enable creation of multiple user profiles.

18. The network of claim 17, wherein icon based representation is used to represent the candidate nodes.

19. The network of claim 16, wherein the server is configured to display actual career path of candidate nodes in a graphical format using stored information.

20. The network of claim 19, wherein basis the candidate profile, the recruiter node sends a interview offer.

21. The network of claim 16, wherein after the recruiter node sends the service offer after the interview to the selected candidate node, the server node automatically exposes the number service offers (if any) received by the candidate node from other recruiter nodes.

22. The network of claim 21, wherein the service offers (if any) exposed by the server node contains no information about the recruiter nodes and the job offers.

23. The network of claim 22, wherein the candidate node can further choose to expose more information about the recruiter nodes and the service offers such as name of the company, job profile and salary offered.

24. An interaction facilitation system, the system comprising:
a candidate node;
a service seeker node;
an interface module for receiving information from candidate node;
wherein using the interface module, the candidate node populates information to be used by the service seeker node and upon analysis of the said information mark and execute necessary further action.

25. The system of claim 24, wherein the said information includes details of a candidate's daily work output and tasks completed.

26. The system of claim 24, wherein the candidate node populates information by filing a predefined form.

27. The system of claim 24, wherein candidate node is accessed by a job seeker

28. The system of claim 24, wherein service seeker node is accessed by a recruiter
